(19) United States
(12) Patent Application Publication
(10) Pub. No.: US 2009/0201433 A1
(43) Pub. Date: Aug. 13, 2009

(54) Panel Detaching Mechanism

(76) Inventor: Shun Hayashi, Gunma-ken (JP)

Correspondence Address: CARR & FERRELL LLP, 2200 GENG ROAD, PALO ALTO, CA, 94303, US

(21) Appl. No.: 12/366,814

(22) Filed: Feb. 6, 2009

(30) Foreign Application Priority Data
Feb. 7, 2008 (JP) 2008-028203
Feb. 7, 2008 (JP) 2008-028204

(51) Int. Cl. H04N 5/64

(52) U.S. Cl. 348/837; 348/E05.128

(57) ABSTRACT

A panel detaching mechanism that can detach a panel from a main body while simplifying the structure in front of the panel is provided. In an car audio system, a lock unit latches an operation panel with a support unit in the state where the panel front face is opened outwards, and releases the latching of the operation panel with the main body when a user presses a detach button. A tilt mechanism pulls out the panel bottom face out more than other outside faces such as the panel top face from the state where the operation panel is at the standard position with the operation panel latched with a support unit, by pulling out the support unit. The detach button is arranged on the panel bottom face.

### CROSS-REFERENCE TO RELATED APPLICATION

The present application claims the priority benefit of Japanese patent application number 2008-028203 filed Feb. 7, 2008 and Japanese patent application number 2008-028204 filed Feb. 7, 2008. This disclosure of each of the aforementioned applications is incorporated herein by reference.

### BACKGROUND OF THE INVENTION

1. Field of the Invention

The present invention generally relates to a panel detaching mechanism. More specifically, the present invention relates to a panel detaching mechanism in which a panel is detached from a main body.

2. Description of the Related Art

Car audio systems or car navigation systems are widely mounted on vehicles. Many such systems are expensive hence there is a fear of theft during absence of car occupants. Therefore, a car electronic device may have an operation panel with a lock where the main body can be released by pressing a release key provided on the front face of the panel. Such a device is disclosed in Japanese Patent Laid-Open No. Hei 6-239182. A panel detaching mechanism in which latching with the main body of a system is released by pressing a lock release button provided on the front face of the system thereby allowing the panel to be detached from the main body of the system is disclosed in Japanese Patent Laid-Open No. Hei 10-230796.

A detachable mechanism of a control unit in which one-end engagement can be released by, for example, a hook biased by a tensile coil spring while holding the control unit is presented in Japanese Utility Model laid-Open No. Hei 5-44702.

In many cases, a display or operation buttons are arranged on the front face of such a panel. Arranging a button for detaching a panel on the front face of the panel, however, leads to occupation of a part of the front face and may reduce space for arranging a display or operation buttons.

In Japanese Utility Model laid-Open No. Hei 5-44702, a control unit is pulled out to the near side at a suitable distance after the latching is released. Hence a relatively long tensile coil spring and a hook, having its length corresponding to the coil, is needed. Such a hook and a tension coil spring occupy a large amount of space in front of the panel that is arranged behind the control unit. On the other hand, car audio systems or the like have recently been required to be increasingly sophisticated despite the limited space in vehicles. It has therefore become a serious problem to save space within a device in order to realize various functions.

### SUMMARY OF THE CLAIMED INVENTION

Embodiments of the present invention solve the problems stated above. A general purpose of the invention is to simplify the structure of the front face of the panel and to provide a panel detaching mechanism that can suitably detach a panel from the main body. Another purpose of the invention is to realize the space saving within a system having a panel detaching mechanism.

According to one embodiment, a panel detaching mechanism comprises an operating member adapted to be operated by a user and a latch mechanism adapted to latch a panel with a main body. The latching releases when a user operates the operating member. The operating member is arranged on one of the outside faces in contact with the front face of the panel.

Another embodiment of the present invention also relates to a panel detaching mechanism. The panel detaching mechanism comprises a latch mechanism adapted to latch a panel with a main body in a detachable manner and a push-out mechanism adapted to push out the panel relative to the main body so that a predetermined outside face among the outside faces in contact with the front face of the panel is pushed out when latching with the main body by the latch mechanism is released. The latch mechanism and the push-out mechanism are arranged on a virtual straight line, parallel with the predetermined outside face at a position near the predetermined outside face from the center of the panel.

Another embodiment of the present invention also relates to a panel detaching mechanism. The panel detaching mechanism comprises a latch mechanism adapted to latch a panel with a main body in a detachable manner with the front face of the panel exposed. A detachment guide mechanism is adapted to guide the panel when the latch with the main body is unlatched. A detachment limiting mechanism is adapted to limit movement of the panel within a predetermined range of the guide direction. The latch mechanism releases the latching between the panel and the main body so that the panel can be pulled out from a predetermined outside face among the outside faces in contact with the front face of the panel from the main body. The latch mechanism and the detachment limiting mechanism are arranged on a virtual straight line, parallel with the predetermined outside face at a position near the predetermined outside face from the center of the panel.

### BRIEF DESCRIPTION OF THE DRAWINGS

FIG. 1 is a perspective view of a car audio system;

FIG. 2 is a perspective view of the car audio system in a state where the operation panel is pulled out;

FIG. 3 is a perspective view of the car audio system in a state where the operation panel is completely detached;

FIG. 4 is a front view of the operation panel;

FIG. 5 is a bottom view of the operation panel;

FIG. 6(A) is a side view of the car audio system just before the operation panel is detached;

FIG. 6(B) is a side view of the car audio system immediately after the operation panel has been detached;

FIG. 7 is a back view of the operation panel;

FIG. 8 is a front view of a support unit;

FIG. 9 is a perspective view of a stopper;

FIG. 10 is a perspective view of the support unit from behind;

FIG. 11(A) is a drawing illustrating a state where the operation panel is latched with the support unit;

FIG. 11(B) is a drawing illustrating a state immediately after the detach button was pressed from the state of FIG. 11(A);

FIG. 11(C) is a drawing illustrating the state where the panel top face is pressed from the state of FIG. 11(B); and

FIG. 11(D) is a drawing illustrating the state where the operation panel is pulled out to the near side of the system from the state of FIG. 11(C).

### DETAILED DESCRIPTION

The invention will now be described by reference to preferred embodiments. This does not intend to limit the scope of the present invention but only to exemplify the invention. Embodiments of the present invention will be described in detail with reference to the drawings.

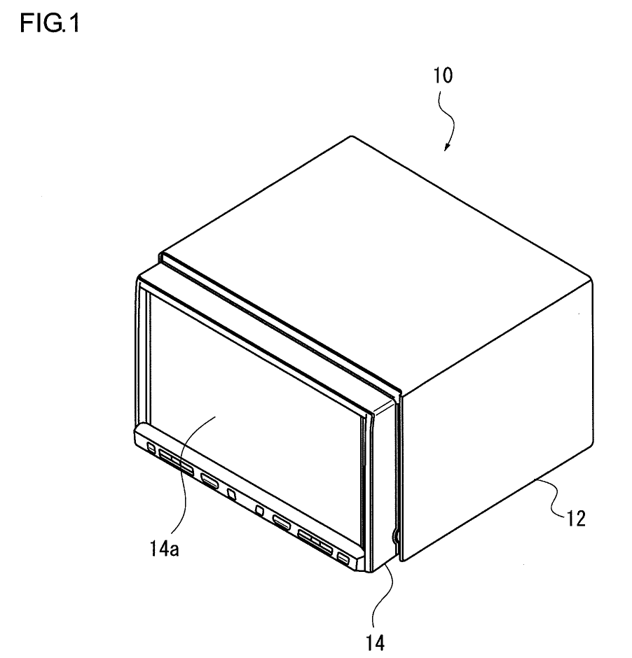

FIG. 1 is a perspective view of car audio system 10. The car audio system 10 of FIG. 1 is an audio system mounted on the instrument panel or the like of a vehicle and includes main body 12 and operation panel 14.

The main body 12 has a rectangular parallelepiped shape, the whole of which is housed in an instrument panel of a vehicle when mounted thereon. The operation panel 14 has substantially the same width and height as those of the main body 12 and a shorter depth than that of the main body 12. The operation panel 14 is equipped in front of the main body 12. When the car audio system 10 is mounted on a vehicle, the system 10 is arranged on the front face of the instrument panel of a vehicle in the state of being exposed outwards so that the panel front face 14a can be seen by an occupant of a vehicle. The operation panel 14 is latched with the main body 12 at the standard position where the panel front face 14a is perpendicular to the car audio system when the car audio system is put on a horizontal plane in the usual state where the operation panel 14 is not pulled out.

Alternatively, a car navigation system may be adopted instead of an car audio system. Or the audio system may be, for example, a home audio system without being limited to one in a car.

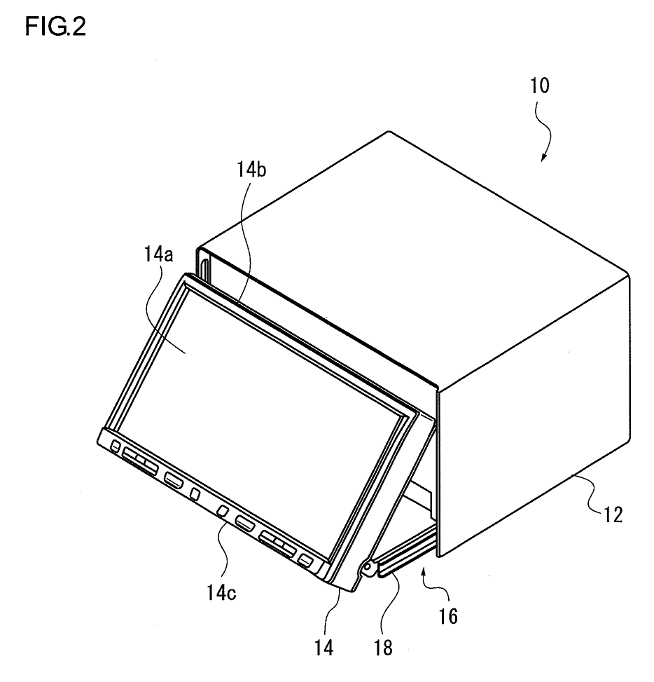

FIG. 2 is a perspective view of the car audio system 10 in a state where the operation panel 14 is pulled out. The car audio system 10 is provided with a support unit (not illustrated) and a tilt mechanism. The operation panel 14 is latched with the support unit. The panel top face 14b and the panel bottom face 14c are parts of the outside faces in contact with the panel front face 14a. The tilt mechanism 16 functions such that the panel bottom face 14c can be pulled out more than other outside faces. For example, the panel top face 14b with the operation panel 14 latched with the support unit from the state where the operation panel 14 is in the standard position by pulling out the support unit.

Specifically, the tilt mechanism 16 includes a motor (not illustrated), a rack gear mechanism (not illustrated), and two rods 18. A tilt button (not illustrated) is provided on the panel front face 14a. When a user presses the tilt button, the motor is operated by a control unit (not illustrated) which comprises a microcomputer provided within the main body 12 or the like so that the rods 18 respectively extend out from the right and left lower parts of the front face of the main body 12 through the rack gear mechanism. The tips of the two rods 18 are pivoted on the lower parts of the support units and, as the rods 18 move forward, the panel bottom face 14c moves forward and the panel top face 14b moves downwards with the whole operation panel 14 being tilted diagonally.

Such car audio systems are generally expensive. There is a fear of theft during absence of car occupant if the car audio system is left in the vehicle. Therefore, the car audio system 10 according to the present embodiment is provided so that the operation panel 14 is detachable from the main body 12.

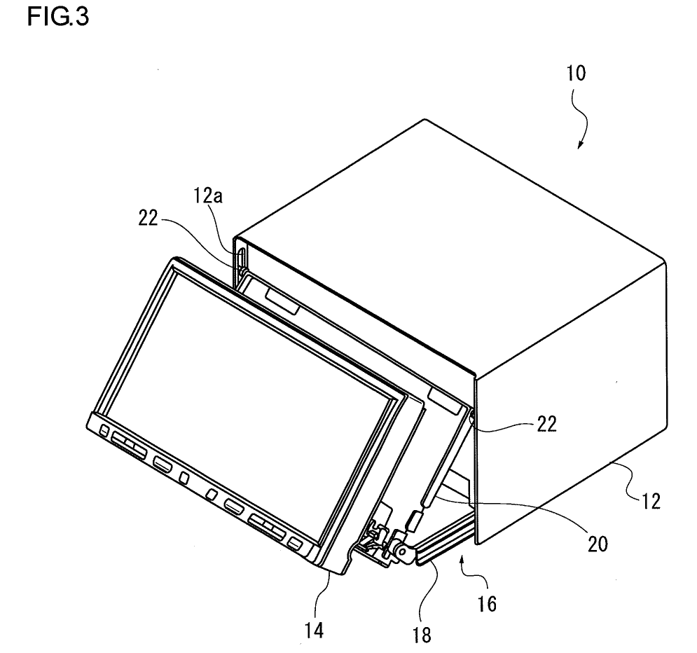

FIG. 3 is a perspective view of the car audio system in a state where the operation panel 14 is detached. The operation panel 14 is provided to be detachable to the support unit 20 that latches the operation panel 14 covering the back face of the operation panel 14. In the car audio system 10 of the present embodiment, the operation panel 14 can be respectively attached to and detached from the support unit 20 where the operation panel 14 is at the standard position or is pulled out by the tilt mechanism 16.

Guide shafts 22 are secured both on the upper part of the right side and on the upper part of the left side of the support unit 20. Each of the guide shafts 22 is inserted through a guide part 12a, a long hole extending in the vertical direction, which is provided in the lateral front part of the main body 12. This allows the panel top face 14b to move downwards smoothly when the panel bottom face 14c is pulled out by the tilt mechanism 16.

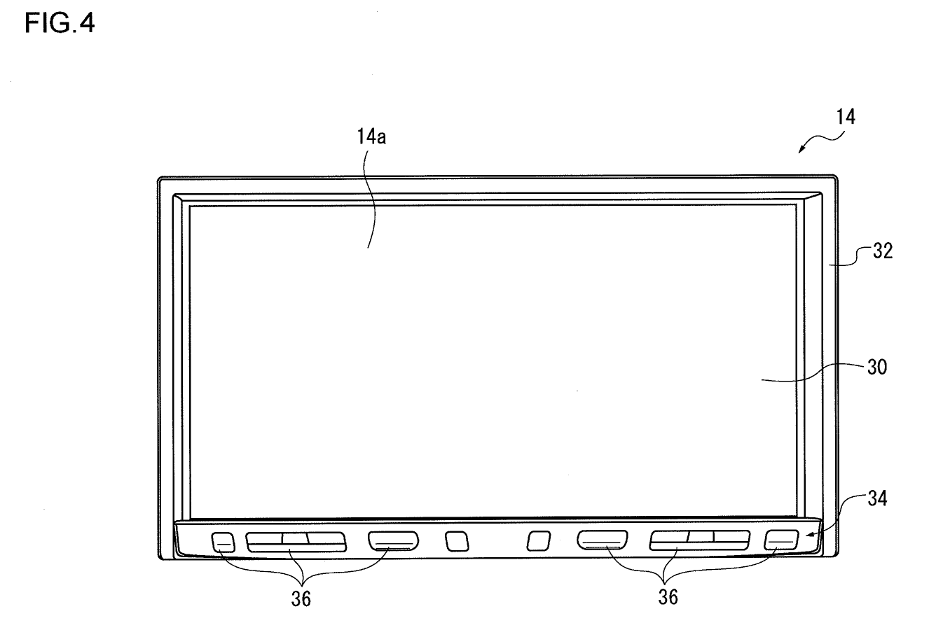

FIG. 4 is a front view of the operation panel 14. The panel front face 14a is provided with a display 30 and a control panel 34. The display 30 has a screen slightly smaller than the size of the panel front face 14a. A frame-shaped front cover 32 is provided on the outer edge of the display 30. The control panel 34 includes a plurality of operation buttons 36, which are arranged in the lower front face of the front cover 32.

Alternatively, the display 30 may be a touch panel. In addition, a display may be solely provided on the panel front face 14a without a control panel. This can lead to increase the size of display. A control panel may also be solely provided on the panel front face 14a without a display.

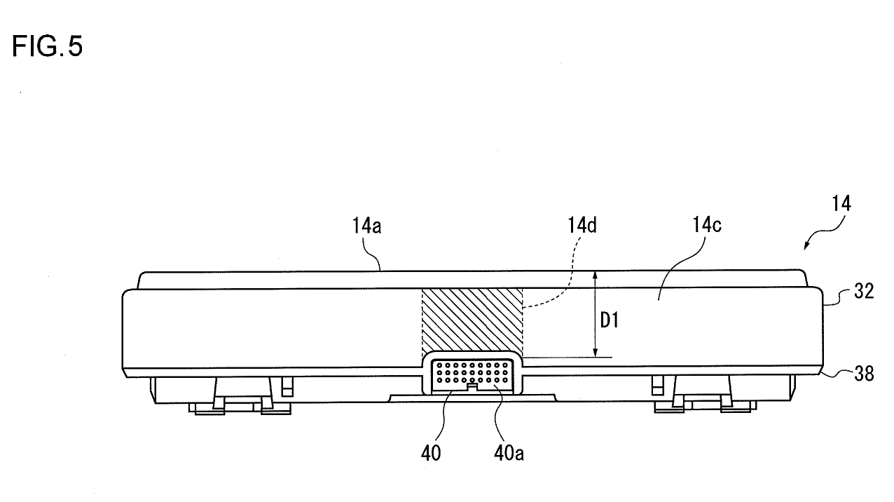

FIG. 5 is a bottom view of the operation panel 14. The opening of the front cover 32 on the rear side of the system is covered with a rear cover 38. Each of the outside faces in contact with the panel front face 14a is formed with the outside face of the front cover 32.

According to the present embodiment, a detach button 40 is provided on the panel bottom face 14c. This can lead to more effective utilization of the panel front face 14a than the case that a detach button is provided on the panel front face 14a. In the present embodiment, arranging the detach button 40 on the panel bottom face 14c makes it possible to increase the size of display 30. A user may sometimes press the detach button by mistake if the detach button 40 is arranged on the panel front face 14a. Reducing user operation mistake to detach button 40 can be achieved by arranging the detach button 40 on the panel bottom face 14c.

The detach button 40 is biased downwards by a spring (not illustrated) so that a downward movement of the detach button 40 is limited at an initial position where the operating face 40a of the button, which is the surface of the button, is positioned on the same level as the panel bottom face 14c. This makes it possible to push the detach button 40 into the operation panel 14. The detach button 40 functions as an operating member adapted to be operated by user. Many minute convexes are formed on the operating face 40a, taking into consideration that a user may recognize the position of the detach button 40 by touch without seeing it.

The detach button 40 is arranged at a position apart by a predetermined distance D1 from the panel front face 14a and a holding part 14d with which a user can hold the panel is provided between the panel front face 14a and the detach button 40 located on the panel bottom face 14c. Accordingly, the detach button 40 is arranged so that the holding part 14d is positioned between the panel front face 14a. Alternatively, a lever or the like may be provided instead of the detach button 40 and the latching between the operation panel 14 and the main body 12 may be released by operating the lever.

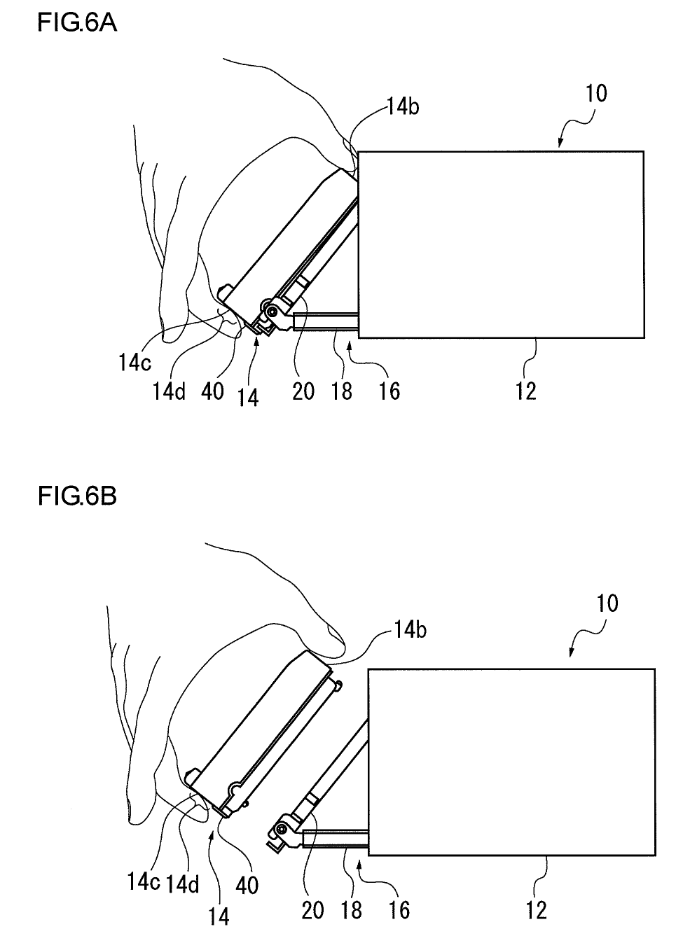

FIG. 6(A) is a side view of the car audio system 10 just before the operation panel 14 is detached. The car audio system 10 according to the present embodiment is suitable for the 2DIN (Deutsche Industrie Normen) and operation panel 14 is formed so as to have a height of about 100 mm and a width of about 178 mm. The distance between the panel top face 14b and the panel bottom face 14c is small. This allows a user to hold the operation panel 14 with one hand, placing his/her thumb on the panel top face 14b and middle finger or the like on the panel bottom face 14c as illustrated, for example, in FIG. 6(A). At the same time, a user can press the detach button 40 with the tip of the finger placed on the holding part 14d. This allows a user to simultaneously press the detach button 40 with the operation panel 14 held. In addition, the detach button 40 can be pressed with the operation panel 14 firmly held. This allows a user to detach the operation panel 14 from the support unit 20 in a stable state.

FIG. 6(B) is a side view of the car audio system just after the operation panel 14 has been detached. As seen above, a user can completely detach the operation panel 14 from the support unit 20 while holding the operation panel 14 with one hand.

The car audio system 10 is not limited to an audio system suitable for the 2DIN. Almost any person can hold the panel with one hand when the distance between the opposing outside faces of the panel is 130 mm or less. Accordingly, the car audio system 10 may have two opposing outside faces between which the distance is 130 mm or less, which is the distance one can hold the system with one hand and the detach button 40 may be arranged on one of the two outside faces.

The configurations and operations for detaching the operation panel 14 in the car audio system 10 will be described in detail below.

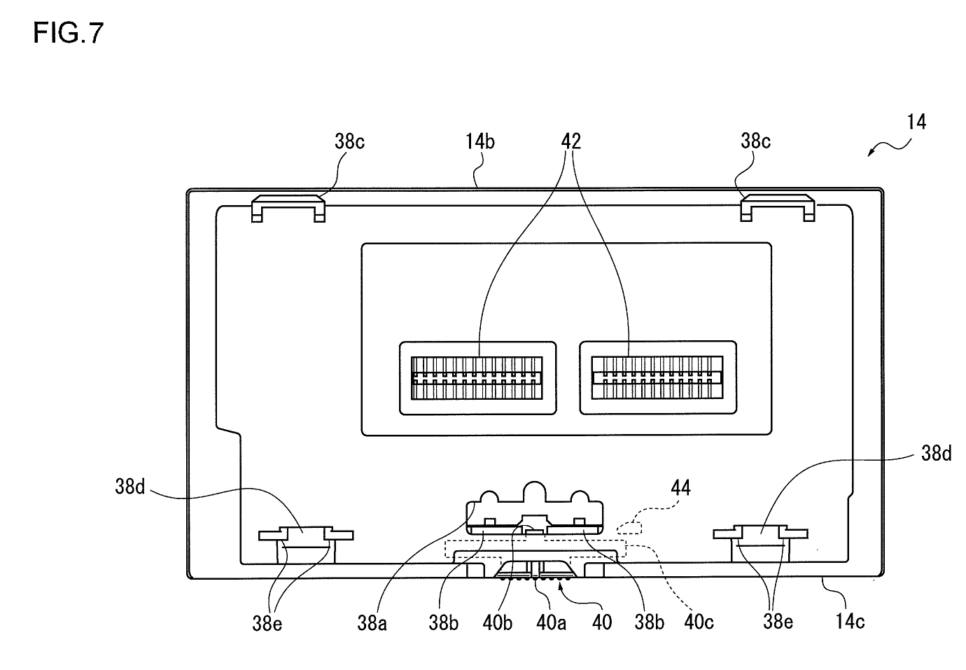

FIG. 7 is a back view of the operation panel 14. Hereinafter, assuming that the outside face of a rear cover 38 corresponding to the back face of the operation panel 14 is the front face, the description of the face will be made. A first concave portion 38a is provided in the lower center part of the front face of the rear cover 38. The first concave portion 38a has a horizontally-long rectangular shape and is concaved into the operation panel 14. Projections 38b are provided within the first concave portion 38a. Projections 38b extend upwards from the lower inner face of the first concave portion 38a. In addition, latch projections 38c extending upwards are provided in each of the right and left upper parts of the rear cover 38. Further, second concave portions 38d are provided in the right and left lower parts on the front face of the rear cover 38. Each of the second concave portions 38d is concaved into the operation panel 14. Projections 38e are provided within the second concave portion 38d. Projections 38e are extending downwards from the top inner face of the second concave portions 38d.

Two male connectors 42 are arranged horizontally side-by-side at the center on the front face of the rear cover 38. Each of the male connectors 42 has a horizontally extending projection and a plurality of terminals that are arranged horizontally and positioned side-by-side on the surface of the projection.

The detach button 40 has a projection 40b and an arm 40c. The projection 40b is formed so as to extend upwards from the operating face 40a in the perpendicular direction within the operation panel 14. The projection 40b is provided so as to project into the first concave portion 38a when the operating face 40a is pressed by the user.

The arm 40c is formed so as to extend horizontally from the drum section of the projection 40b in the operation panel 14. A substrate (not illustrated) is arranged on the rear side of the rear cover 38 and a switch 44 is provided on the substrate. When a user presses the operating face 40a, the arm 40c moves upwards and presses the switch 44 thereby turning it on. When the switch 44 is turned on, electric conductions in all terminals of the male connector 42 are disconnected. This allows male connector 42 to be detached from a female connector, described later, with electric conduction disconnected.

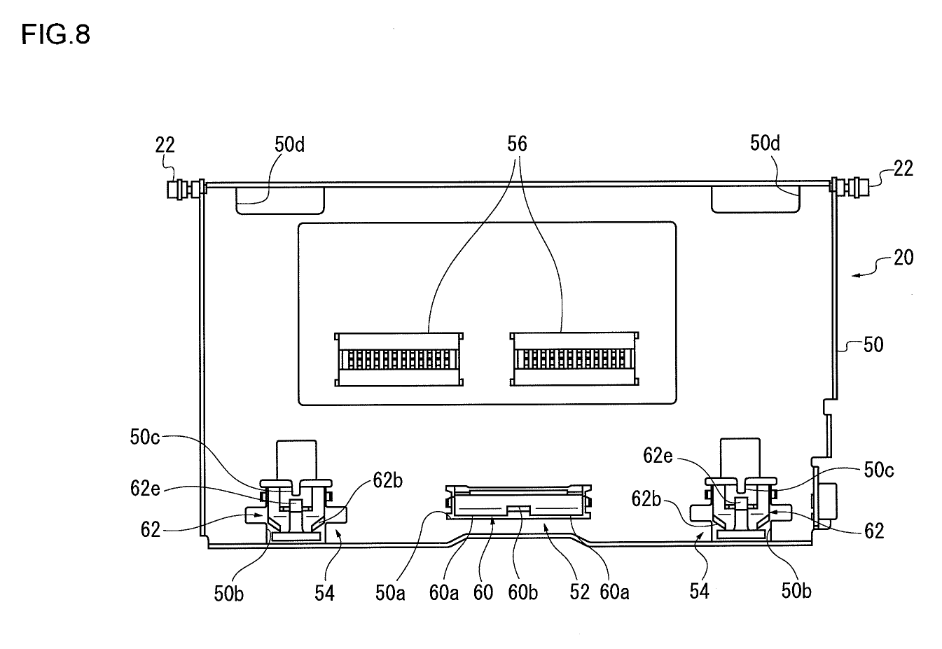

FIG. 8 is a front view of the support unit 20. The support unit 20 has a front bracket 50, a lock unit 52, a stopper unit 54, and a female connector 56. The front bracket 50 is formed by sheet metal processing into a rectangular shape that is horizontally-long with a bent part on its perimeter. The front bracket 50 is arranged so that the bent part extends to the front direction of the system. The front bracket 50 supports the operation panel 14 in a detachable manner. Accordingly, the front bracket 50 functions as a support member for the operation panel 14. The front bracket 50, which corresponds to the front face of the main body 12, is hereinafter assumed as the front face of the front bracket 50 and corresponding description is made.

The lock unit 52 has a latch member 60. Two hook parts 60a projecting downwards are horizontally formed, side-by-side in the latch member 60. A concave portion 60b is formed between the two hook parts 60a. The concave portion 60b is concaved upwards from the bottom end of the hook part 60a. A first opening 50a, which is a horizontally-long rectangular-shape, is provided in the lower center of the front bracket 50. The latch member 60 is inserted into the first opening 50a from the back face side of the front bracket 50 and is arranged so that the hook part 60a and the concave portion 60b project from the front face of the front bracket 50.

The hook part 60a latches the operation panel 14 with the main body 12 by being inserted into the first concave portion 38a provided on the rear cover 38 and by engaging with the projection 38b. Accordingly, the lock unit 52, including the latch member 60, and the projection 38b both function as a latch mechanism. On the other hand, when a user presses the detach button 40 with the operation panel 14 latching with the main body 12, the concave portion 60b is pushed upwards by the projection 40b of the detach button 40. The latching between the hook part 60a and the projection 38b is then released.

Two latching holes 50d are provided in the right and left upper parts of the front bracket 50, respectively. When the engagement projection 38c provided on the rear cover 38 latches with the engagement hole 50d and the latch member 60 latches with the projection 38b, the operation panel 14 is latched with the main body 12. The engagement hole 50d and the engagement projection 38c also function as a latch mechanism.

When the operation panel 14 is detached from the main body 12 by releasing the latching between the hook part 60a and the projection 38b, the engagement hole 50d and the engagement projection 38c guide the operation panel 14 so that they turn around the latching point between them. Accordingly, the engagement hole 50d and the engagement projection 38c function as a detachment guide mechanism adapted to guide the operation panel 14 when the latching between the hook part 60a and the projection 38e is released.

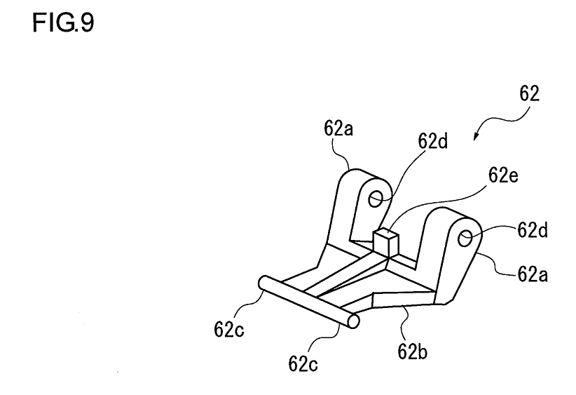

The stopper unit 54 has a stopper 62. The description about the shape of the stopper 62 is made with reference to FIG. 9.

FIG. 9 is a perspective view of the stopper 62. The stopper 62 is formed into an L-shaped flat panel in which two shaft support parts 62a and a push-out part 62b formed into a plate shape are integrally connected together at their ends. A pair of latching rods 62c are formed at the tip of the push-out part 62b. The pair of latching rods 62c project horizontally in both directions from the push-out part 62b. Two shaft insertion holes 62d, which penetrate coaxially, are provided in the two shaft support parts 62a. The stopper 62 is pivoted on the front bracket 50 by inserting a shaft, described later, through the shaft insertion holes 62d. A projection 62e is formed between the two shaft support parts 62a. The projection 62e projects upwards from the push-out part 62b.

Referring back to FIG. 8, two second openings 50b are provided in the right and left lower parts of the front bracket 50, respectively. The stopper 62 is arranged so that the push-out part 62b projects from the front face of the front bracket 50. As stated later, the stopper 62 is pivoted on the front bracket 50. The projection 50c limits the turn of the stopper 62 by contacting with the projection 62e.

The stopper 62 limits the turn of the operation panel 14 around the latching point between the engagement hole 50d and the engagement projection 38c by engaging with the projection 38e provided in the rear cover 38. Accordingly, the stopper unit 54 and the projection 38e function as a detachment limiting mechanism adapted to limit the movement of the operation panel 14 within a predetermined range of the guide direction when the latching between the latch member 60 and the projection 38b is released. The panel detaching mechanism that detaches the operation panel 14 from the main body 12, comprises the detach button 40, the latch mechanism, the detachment guide mechanism, and the detachment limiting mechanism, which are mentioned above, or the like.

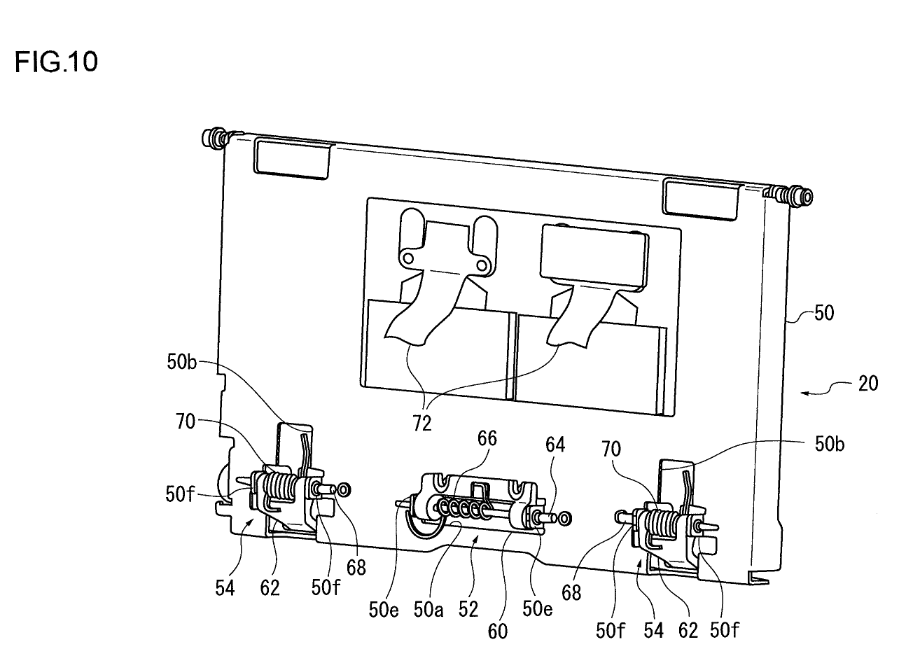

FIG. 10 is a perspective view of the support unit 20 from behind. The lock unit 52 further has a shaft 64 and a coil spring 66. The front bracket 50 is provided with first bent parts 50e, which project from the back face of the bracket at each end of the first opening part 50a. The latch member 60 is arranged between a pair of the first bent parts 50e and pivoted on the front bracket 50 by the shaft 64. At the time, the shaft 64 is inserted through the center of the coil spring 66. The coil spring 66 provides a biasing force in the direction of the turn by which the hook part 60a moves downwards to the latch member 60.

The stopper unit 54 further has a shaft 68 and a spring 70. A pair of second bent parts 50f is provided with the front bracket 50. The pair of second bent parts 50f project towards the back face of the bracket at each end of the second openings 50b. The stopper 62 is arranged between the pair of the second bent parts 50f and pivoted on the front bracket 50 by the shaft 68. The spring 70 provides a biasing force in the direction of the turn by which the tip of the push-out part 62b moves upwards to the stopper 62.

As illustrated in FIG. 10, the lock unit 52 and the two stopper units 54 are arranged so that they are positioned on a virtual straight line parallel with the bottom face of the front bracket 50, in the vicinity of the bottom face of the front bracket 50 that is pulled out by the tilt mechanism 16. This limits the area where the lock unit 52 and the stopper units 54 are arranged and allows an area in the front face of the main body 12, which is exposed when the operation panel 14 is pulled out by the tilt mechanism 16 or the like to be used effectively. In the present embodiment, an insertion slot (not illustrated) for both CD (Compact Disc) and DVD (Digital Versatile Disc) and an insertion slot (not illustrated) for memory cards are provided on the front face of the main body 12, which is exposed when the operation panel 14 is pulled out by the tilt mechanism 16. It is noted that the lock unit 52 and the two stopper units 54 may be arranged in other positions near the bottom face of the front bracket 50, located under the center of the operation panel 14, without being limited to the above position.

Two flat cables 72 are provided corresponding to each of the two female connectors 56. Since the terminals of the female connectors 56 are horizontally provided and positioned side-by-side, each of the flat cables 72 is formed into a plate shape so as to be easily curved around a horizontally-extended axis. This allows the flat cable 72 to be curved easily when the lower part of the support unit 20 is tilted and pulled out by the tilt mechanism 16.

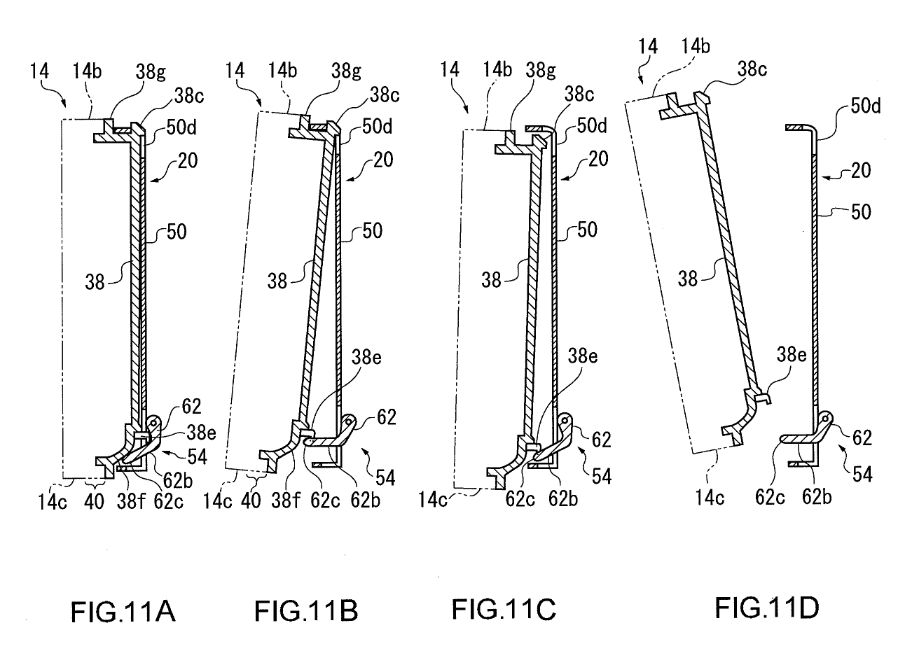

Procedures for detaching the operation panel 14 from the support unit 20 will be described with reference to FIGS. 11(A) to 11(D). It is noted that the outline of the operation panel 14 is illustrated by simplifying with a two-dot chain line in order to make it easily understandable. In addition, FIGS. 11(A) to 11(D) illustrate cross sectional views in which the operation panel 14 and the support unit 20 are cut face-wise by passing through the engagement projection 38c and the stopper 62.

FIG. 11(A) is a drawing illustrating a state where the operation panel 14 is latched with the support unit 20. In the lower part of the rear cover 38, an inclined part 38f is formed that inclines so as to draw itself nearer to the front of the system as it approaches the panel bottom face 14c. The tip of the stopper 62 contacts the inclined part 38f. The stopper 62 is provided with a biasing force by the spring 70 by which the tip thereof pushes out the inclined part 38f.

FIG. 11(B) is a drawing illustrating the state immediately after the detach button 40 was pressed from the state of FIG. 11(A). When a user presses the detach button 40 to release the latching between the hook part 60a and the projection 38b, the stopper 62 pushes out the lower part of the operation panel 14 from the support unit 20. Accordingly, the stopper unit 54 also functions as a push-out mechanism.

An edge part 38g is formed on the front side of the engagement projection 38c on the top face of the rear cover 38. When the engagement projection 38c engages with the engagement hole 50d, the bent part of the front bracket 50 is positioned between the engagement projection 38c and the edge part 38g. As the inclined part 38f is pushed out by the push-out part 62b, the operation panel 14 is spaced from the support unit 20 while turning around the engaging point between the engagement projection 38c and the engagement hole 50d. During the turn, the bent part of the front bracket 50 is continuously positioned between the engagement projection 38c and the edge part 38g, hence the engaging between the engagement projection 38c and the engagement hole 50d is maintained.

The tip of the latch member 60 slides upwards on the inclined part 38f as the operation panel 14 rotationally moves and the latching rod 62c latches with the projection 38e when the operation panel 14 rotationally moves at a predefined angle. This limits the turning range of the operation panel 14, which turns around the engaging point between the engagement projection 38c and the engagement hole 50d. The stopper 62 is biased by the spring 70 to raise the projection 38e upwards. Hence, even if a user release his or her hand from the operation panel 14, the engagement between both the engagement projection 38c and the engagement hole 50d and between the projection 38e and the latching rod 62c are maintained and the operation panel 14 is supported by the support unit 20. This can avoid the operation panel 14 from falling just after the detach button 40 is pressed.

FIG. 11(C) is a drawing illustrating the state where the panel top face 14b is pressed from the state of FIG. 11(B). The stopper 62 turns against the biasing force created by the spring 70, and the operation panel 14 moves downwards. When the operation panel 14 moves downwards somewhat, the engaging between the engagement hole 50d and the engagement projection 38c is released. This allows the upper part of the operation panel 14 to be drawn.

FIG. 11(D) is a drawing illustrating the state where the operation panel 14 is pulled out from the state of FIG. 11(C) to the nearest side and upper side of the system. Then, the latching between the latching rod 62c and the projection 38e is also released and the operation panel 14 is completely separated from the support unit 20. As stated above, a series of operations by which the operation panel 14 is detached from the main body 12 can be conducted with one hand while holding the operation panel 14 therewith by arranging the detach button 40 on the bottom face 14c of the operation panel 14.

The present invention should not be limited to the embodiments stated above. An appropriate combination of each element of the above embodiments is effective as an embodiment of the invention. Further, various modifications such as design modifications can be made with respect to the each embodiment based on the knowledge of those skilled in the art and an embodiment with such a modification should fall within the scope of the present invention. Certain examples are discussed below.

According to an embodiment, a plurality of (for example, two) detach buttons are provided on the panel bottom face 14c. The latch member 60 is raised in its hook part 60a by connecting each of the detach buttons with the concave portion 60b when any one of the plurality of detach buttons is pressed by a user. This allows the latching with the projection 38b to be released. This allows detach buttons to be arranged, for example, in both the driver side and the passenger side.

According to another embodiment, the latching between the stopper 62 and the projection 38e can be released by pulling the operation panel 14 around the latching point between the engagement projection 38c and the engagement hole 50d from the state of FIG. 11(B). Specifically, in this embodiment, an inclined part is provided in a part of the projection 38e where the projection 38e latches with the latching rod 62c. Hence, the engagement can be released by pulling out the lower part of the operation panel 14 with a somewhat strong force even when the projection 38e and the latching rod 62c are latched. This allows the operation panel 14 to be easily and completely detached from the support unit 20 without pressing the operation panel 14 downwards once or the like.

What is claimed is:

1. A panel detaching mechanism, comprising:
an operating member configured for user operation; and
a latch mechanism configured to latch a panel to a main body, the latch mechanism further configured to release the latching of the panel and the main body when a user operates the operating member, wherein the operating member is arranged on an outside face in contact with the front face of the panel.

2. The panel detaching mechanism of claim 1, wherein the operating member is a detach button that may be pushed from a predefined initial position into the panel, and wherein the latch mechanism releases the latching of the panel and the main body when the detach button is pressed from the initial position into the panel by a user.

3. The panel detaching mechanism of claim 1, further comprising:
a detachment guide mechanism configured to guide the panel when the latching of the panel and the main body is released and the panel is detached from the main body; and
a detachment limiting mechanism configured to limit movement of the panel within a predetermined range of the guide direction.

4. The panel detaching mechanism of claim 3, wherein the detachment limiting mechanism may release the limitation of the movement of the panel when the panel is moved in a predefined direction different from the guide direction.

5. The panel detaching mechanism of claim 1, wherein the main body includes:
a support member configured to latch the panel, and
a tilt mechanism configured to pull out the support member from the state where the panel is latched at the standard position so that a predetermined outside face among the outside faces in contact with the front face of the panel is pulled out more than other outside faces with the panel latched therewith, wherein the operating member is arranged on the predetermined outside face.

6. The panel detaching mechanism of claim 1, wherein the operating member is arranged on the bottom face in contact with the front face of the panel.

7. The panel detaching mechanism of claim 1, wherein the operating member is arranged on the outside face of the panel so that the distance between the operating member and the opposing outside face is within a predetermined length so that the panel can be held with one hand.

8. The panel detaching mechanism of claim 1, further comprising a holding part that forms a part of the outside face whereby a user may hold the holding part when detaching the panel, and wherein the operating member is arranged so that the holding part is positioned between the operating member and the front face of the panel.

9. The panel detaching mechanism of claim 1, wherein a plurality of the operating members are provided, and the latch mechanism is configured to release the latching of the panel when any one of the plurality of operating members is operated.

10. The panel detaching mechanism of claim 1, further comprising a display arranged in front of the panel.

11. A panel detaching mechanism, comprising:
a latch mechanism configured to detachably latch a panel with a main body; and
a push-out mechanism configured to push out the panel relative to the main body so that a predetermined outside face among the outside faces in contact with the front face of the panel is pushed out when the latching with the main body by the latch mechanism is released, wherein the latch mechanism and the push-out mechanism are arranged on a virtual straight line parallel with the predetermined outside face at a position near the predetermined outside face from the center of the panel.

12. The panel detaching mechanism of claim 11, wherein the main body includes:
a support member configured to latch the panel; and
a tilt mechanism configured to pull out the support member from the state where the panel is latched at the standard position so that the predetermined outside face of the panel is pulled out more than other outside faces with the panel latched therewith.

13. A panel detaching mechanism comprising:
a latch mechanism configured to detachably latch a panel with a main body;
a detachment guide mechanism configured to guide the panel when the latching with the main body is released; and
a detachment limiting mechanism configured to limit movement of the panel within a predetermined range of the guide direction, wherein the latch mechanism releases the latching between the panel and the main body so that the panel can be pulled out a predetermined outside face among outside faces in contact with the front face of the panel, from the main body, and wherein the latch mechanism and the detachment limiting mechanism are arranged on a virtual straight line parallel with a predetermined outside face at a position near the predetermined outside face from the center of the panel.

14. The panel detaching mechanism of claim 13, wherein the main body includes:
a support member configured to latch the panel; and
a tilt mechanism configured to pull out the support member from the state where the panel is latched at the standard position so that the predetermined outside face of the panel is pulled out more than other outside faces with the panel latched therewith.
